(19) United States
(12) Patent Application Publication
(10) Pub. No.: US 2004/0162642 A1
(43) Pub. Date: Aug. 19, 2004

(54) Thin client power management system and method

(76) Inventors: Marcus Gasper, Victoria (CA); Douglas S. Ransom, Victoria (CA); John C. Van Gorp, Sidney (CA); J. Bradford Forth, Victoria (CA); Daniel J. Wall, Saanichton (CA)

Correspondence Address: BRINKS HOFER GILSON & LIONE, P.O. BOX 10395, CHICAGO, IL, 60610, US

(21) Appl. No.: 10/208,924

(22) Filed: Jul. 31, 2002

Related U.S. Application Data
(63) Continuation-in-part of application No. 09/723,564, filed on Nov. 28, 2000.

(51) Int. Cl. G05D 17/00

(52) U.S. Cl. 700/286; 700/295

(57) ABSTRACT

A power management architecture for an electrical power distribution system, or portion thereof, is disclosed. The architecture includes one or more data sources, such as intelligent electronic devices (“IED's”), distributed throughout the power distribution system to manage and report the flow and consumption of the power from the system. The data sources are linked via a network to one or more decentralized world wide web browser based data processing applications, the browser application allowing multiple users to individually retrieve, process and display the data from a single, or a combination of multiple data sources. The browser application also allows users to manage the data.

### RELATED APPLICATIONS

This application is a continuation-in-part under 37 C.F.R. § 1.53(b) of U.S. patent application Ser. No. 09/723,564, entitled “INTRA-DEVICE COMMUNICATIONS ARCHITECTURE FOR MANAGING ELECTRICAL POWER DISTRIBUTION AND CONSUMPTION”, filed Nov. 28, 2000 (Attorney Docket No. 6270/48) now U.S. Pat. No. ______ , the entire disclosure of which is hereby incorporated by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates to the monitoring and control of intelligent electronic devices (“IED's”) and power management data nodes such as enterprise energy management (“EEM”) systems and databases over the Internet. IED's may be positioned along the supplier's distribution path or within a customer's internal distribution system. IED's include revenue electric watt-hour meters, protection relays, programmable logic controllers, remote terminal units, fault recorders and other devices used to monitor and/or control electrical power distribution and consumption. IED's are widely available that make use of memory and microprocessors to provide increased versatility and additional functionality. Such functionality includes the ability to communicate with remote computing systems, either via a direct connection, e.g. modem or via a network. IED's also include legacy mechanical or electromechanical devices that have been retrofitted with appropriate hardware and/or software allowing integration with the power management system. Typically an IED is associated with a particular load or set of loads that are drawing electrical power from the power distribution system. The IED may also be capable of receiving data from or controlling its associated load. Depending on the type of IED and the type of load it may be associated with, the IED implements a power management function that is able to respond to a power management command and/or generate power management data. Power management functions include measuring power consumption, controlling power distribution such as a relay function, monitoring power quality, measuring power parameters such as phasor components, voltage or current, controlling power generation facilities, computing revenue, controlling electrical power flow and load shedding, or combinations thereof For functions which produce data or other results, the IED can push the data onto the network to another IED or back end server/database, automatically or event driven, or the IED can wait for a polling communication which requests that the data be transmitted to the requester.

An EEM system provides the information and control solutions that enable energy suppliers, service providers and businesses to manage the reliability, quality and economy of energy. An exemplary Enterprise Energy Management System is ION Enterprise™ version 3.0 or higher, manufactured by Power Measurement, located in Saanichton, BC, Canada. In a typical electrical distribution system, electrical energy is generated by an electrical supplier or utility company and distributed to consumers via a power distribution network. Typically there are IED's located at various points in this electrical distribution system, measuring and recording, and in some cases controlling, electrical power consumption, power events, power quality, current, voltages waveforrns, harmonics, transients or other power disturbances. These IED's are linked with software products that leverage the data provided by the IED's to provide a complete real-time information and control network. The software can manage distributed generators, loads or other equipment to avoid utility penalties, or in response to real-time pricing signals or load curtailment programs. It can also allocate costs to departments or processes, reveal extra capacity in times of expansion, and highlight maintenance requirements. ION Enterprise software can support energy contract negotiation and management by aggregating loads across multiple sites and providing the information needed to benchmark energy requirements, verify contract performance, catch billing errors, and develop scenarios based on utility rates choices or load rescheduling.

As the Internet becomes ubiquitous in everyday life, the providers of electrical monitoring products have moved towards providing users with web browser based interfaces to monitor their IED's. Some IED's are directly connected to the Internet utilizing an onboard web server that serves up data from that IED or from legacy meters connected to the web enabled IED. An exemplary web enabled IED is the ION 7500, manufactured by Power Measurement, located in Saanichton, BC, Canada. In other cases data from legacy meters is collected by a web enabled gateway or sub-master device, both of which have an on-board web server that serve up the data. Typically a pre-defined HTML page template is uploaded via File Transfer Protocol (“FTP”) to the web enabled IED, gateway or sub-master device and stored on the device. When a user wants to see the data from a device, they request that HTML page in their web browser. The web browser then queries the device for the HTML page residing in the web server on the device. The device fills in the tags in the HTML page template with current values from the device or connected devices, and returns the page to the web browser. The page is then displayed without further processing in the web browser window according to the HTML tags.

This web page processing functionality is awkward for several reasons. Most significantly, since each web enabled device has its own server with its own pre-defined web pages, the web browser on the client machine is only capable of displaying data from one device at a time. For example, if a user wishes to view data from two IED's at the same time, they would have to open two browser windows linked with the two web enabled devices to view the two IED's. Often, an electrical distribution system will contain hundreds of IED's making it unduly burdensome to view data from each one individually. Furthermore, there is no way to combine the data from two or more IED's on one web page unless those IED's are physically connected to each other in some way, and/or the web server located on one of the devices collects the data from the other devices and presents it in a web page format. With regards to combining data from various sources, some providers of electrical monitoring products use an intermediary device such as a computer with custom server software such as EEM software to collect and combine data before passing it to the web browser. This allows the user to view combined data, but saddles them with the cost, installation and maintenance of the intermediary device and the server software in addition to the IED's.

Accordingly, there is a need to improve upon the existing process of retrieving data from data sources such as IED's and displaying that data via web browsers.

### SUMMARY

The present invention is defined by the following claims, and nothing in this section should be taken as a limitation on those claims. By way of introduction, the disclosed embodiments described below relate to the monitoring and control of IED's. The system includes a network and at least one IED coupled with a portion of the network. The IED includes a web server or other network interface and is connected via the network. A computer is also coupled to the network. This computer has a web browser installed, with an application running in the web browser that is capable of retrieving data from the IED's and the other data sources. The retrieved data is processed and displayed to the user in the web browser window.

The disclosed embodiments further relate to a method of presenting power management data in a web browser window. In one embodiment, the method includes retrieving power management data responses from data sources over a network and processing the data response. The processed response or data is then displayed by a web browser program in a web browser window. The method includes a network and at least one IED coupled with a portion of the electrical power distribution system and further coupled with the network. Each IED is operative to implement a power management function in conjunction with the portion of the electrical power distribution system. The power management function is operative to respond to at least one power management command and generate power management data. Each IED includes a first network interface operative to couple the IED with the network and facilitate transmission of the power management data and receipt of the power management command over the network.

The disclosed embodiments further relate to a power management application coupled with the network and operative to receive and process the power management data from the at least one IED and generate the at least one power management command to the at least one IED to implement the power management function. The architecture further includes at least one computer coupled with the network, the computer comprising a world wide web browser application which retrieves the power management data and also processes the power management data. The web browser application includes a graphical display that displays the processed power management data for a user.

Further aspects and advantages of the invention are discussed below in conjunction with the preferred embodiments.

### BRIEF DESCRIPTION OF THE DRAWINGS

FIG. 1 schematically depicts the general physical layout of the present invention.

FIG. 2a illustrates the prior art system of displaying data retrieved from an IED in a web browser program.

FIG. 2b illustrates one embodiment of an architecture for transmitting data between components in an electrical power distribution system and processing this data.

FIG. 2c illustrates a method for retrieving and displaying power management data, and controlling data nodes for use with the embodiment of FIG. 2b.

FIG. 2d illustrates the method for retrieving and displaying power management data for use with the embodiment of FIG. 2b.

FIG. 3 schematically depicts an exemplary physical layout of a power management system according to the embodiment of FIG. 2b.

FIG. 4 illustrates a screen display for displaying power management data in a browser window according to one embodiment;

FIG. 5a schematically depicts an exemplary physical layout according to one embodiment.

FIG. 5b illustrates a second screen display according to a second embodiment for displaying power management data in a table view in a browser window, using the components of the physical network depicted in FIG. 5a;

FIG. 5c illustrates a third screen display according to a third embodiment for displaying power management data in a graphical view in a browser window, using the components of the physical network depicted in FIG. 5a;

FIG. 6 illustrates a fourth screen display according to a fourth embodiment for displaying power management data in a table view in a browser window.

### DETAILED DESCRIPTION OF THE PRESENTLY PREFERRED EMBODIMENTS

By way of introduction, the disclosed embodiments described below relate to the monitoring and control of IED's and power management data nodes such as EEM systems and databases. The IED's and data nodes include a web server or other network interface and are connected via the Internet or other network with a computer. This computer has a web browser installed, with an application running in the web browser that is capable of retrieving data from the IED's and the other data sources. The retrieved data is processed and displayed to the user in the web browser window.

The disclosed embodiments further relate to a method of presenting power management data in a web browser window. The method includes retrieving data from a power management data source, processing the retrieved data and displaying the processed data in the browser window.

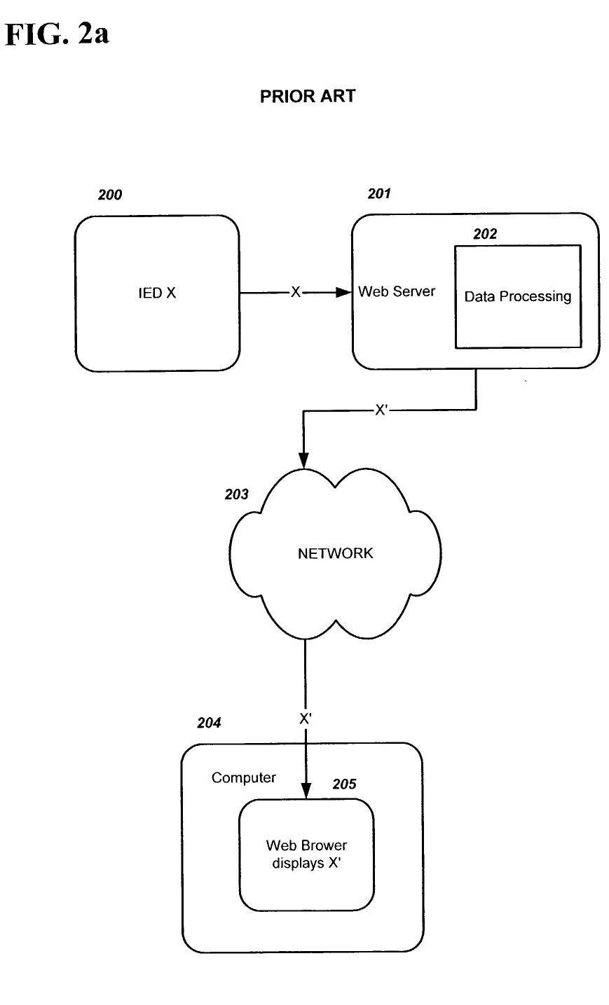

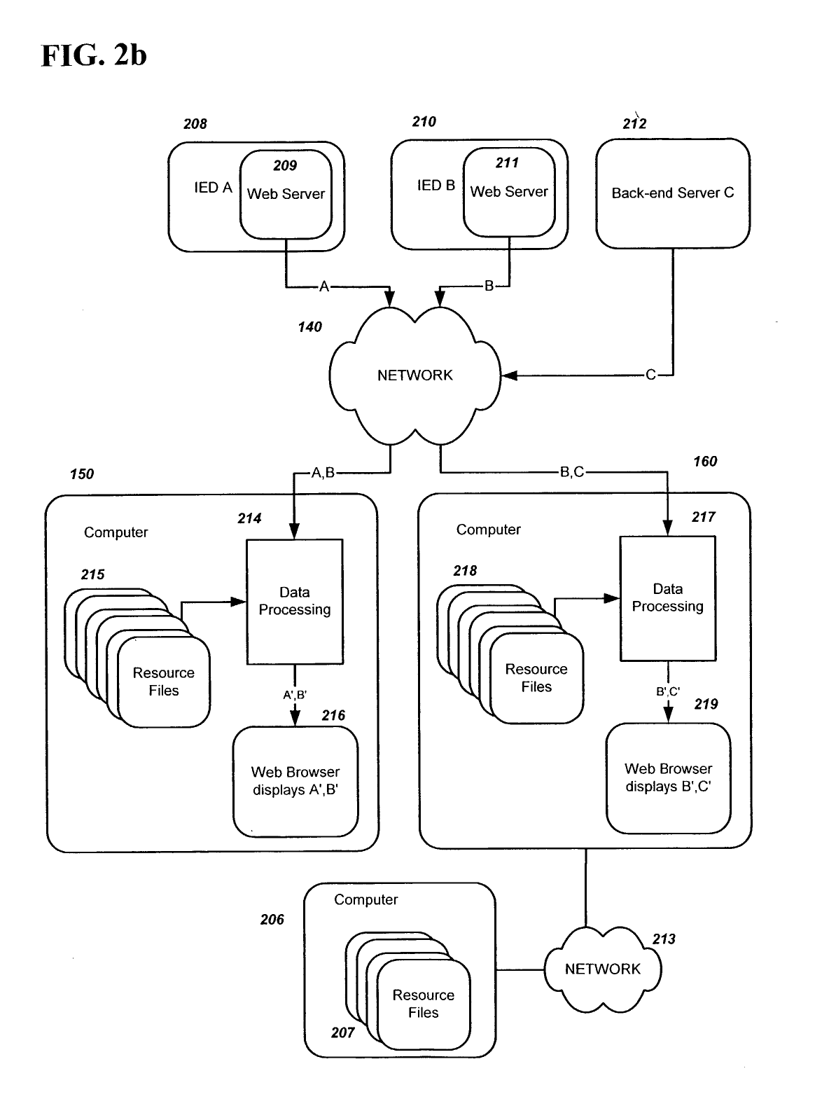

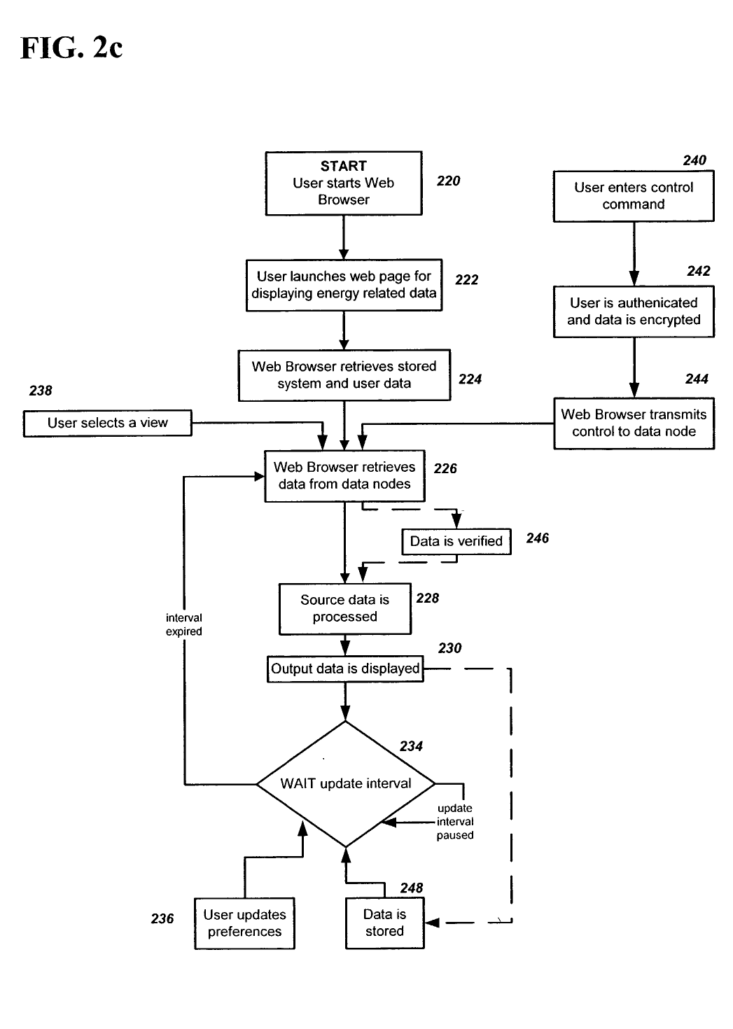

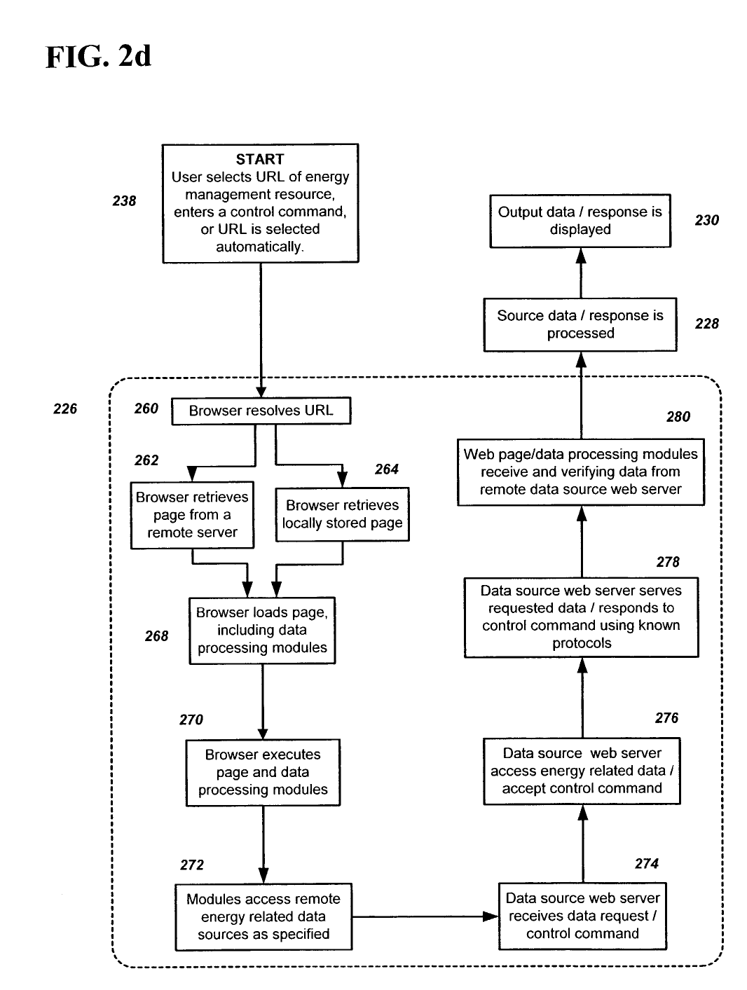

FIG. 2a depicts the prior art wherein intelligent electronic device (“IED”) X 200 is coupled with a Web Server 201. The Web Server 201 may be located within the IED X 200, or in another component (not shown). The Web Server 201 is coupled with a Network 203, which is further coupled with a computer 204. The computer 204 includes a Web Browser program 205 that is executed by the computer 204. When a user requests data from the IED X 200 using the web browser program 205, the request is sent from the computer 204 over the Network 203 to the Web Server 201. The Web Server 201, upon receipt of the request from the computer 204, requests the data from IED X 200, the retrieved data X is processed by the Data Processing component 202, merged with a pre-defined web page template, e.g. HTML or XML template, and the Web Server 201 serves up this merged web page containing the processed data X′ back to the web browser program 205. The web page containing the processed data X′ is transported over the Network 203 and displayed in the Web Browser 205 without further processing.

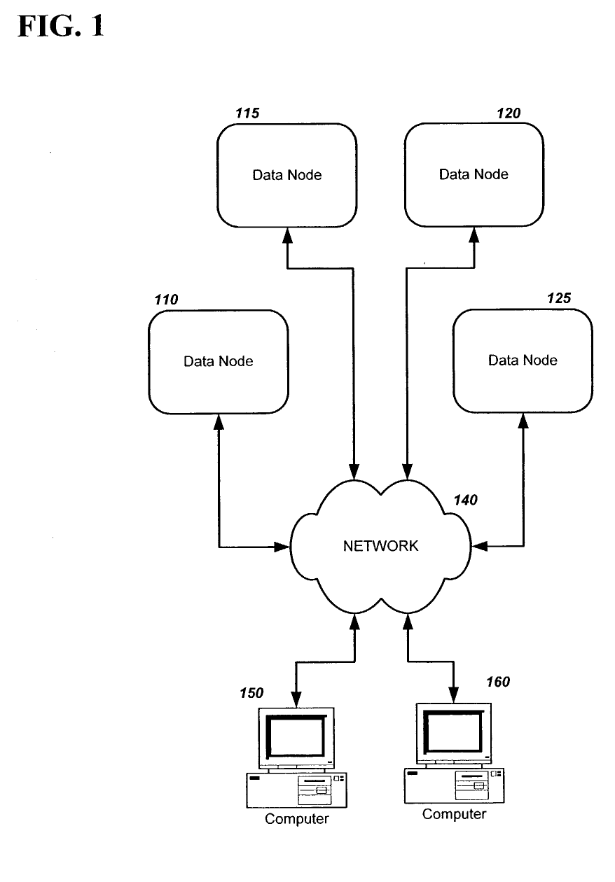

FIG. 1 shows the basic architecture of a power management system according to a first embodiment. Power management systems provide efficient, economical and scalable frameworks of hardware and software upon which power management applications can operate to manage the distribution and consumption of electrical power by one or more utilities/suppliers and/or customers which provide and utilize the power distribution system. In FIG. 1, a power management system comprising at least one computer 150 is coupled with a network 140, which is further coupled with at least one data node 110-125 that include sources of power management data. Herein, the phrase “coupled with” is defined to mean directly connected to or indirectly connected through one or more intermediate components. Such intermediate components may include both hardware and software based components. For the purposes of the present invention, a computer is defined as a processing unit capable of executing a web browser and communicating over a network. The computers include, but are not limited to, personal computers, terminals, network appliances, Personal Digital Assistants (“PDA's”), wired and wireless devices as well as combinations thereof as are presently available or later developed. Further, when discussing web browsers, it will be appreciated that the web browser is operating on a computer as described. Examples of power management data include, but are not limited to, Operation Data such as volts, amps, status, power; Power Quality Data such as harmonics, power factor, reliability (such as number of nines), disturbance data; Consumption Data such as energy and demand; Event Data such as set point actions, status changes and error messages; Financial Data such as energy cost, power factor penalties, revenue data, billing data such as tariffs for gas, water, steam and air; and Environmental Data such as temperature, pressure, humidity and lightening/atmospheric disturbance data. It will be appreciated that power management data can be dynamic, constantly changing data such as continual updates of power usage or it can be static, infrequently changing data such as alarming levels. Data nodes 110-125 of FIG. 1 are capable of communicating directly with a web browser (not shown) located on computer 150 via the Network 140 using a data transfer protocol. Data transfer protocols are standardized rules that describe how network entities interact with each other. These rules define message formatting and error handling as well as other aspects of communications, such as transfer rates, etc. Exemplary data transfer protocols include known protocols such as Hyper Text Transport Protocol (“HTTP”), FTP, Simple Mail Transfer Protocol (“SMTP”), Simple Network Management Protocol (“SNMP”), Telnet, Network News Transport (“NNTP”) as well as other custom or proprietary communications protocols, whether or not TCP/IP based. HTTP is a known protocol used for transferring files across the World Wide Web. These files include text, graphic, image, sound, video and other multimedia files. FTP is a known protocol used for transferring files over TCP connections using strict ownership and access restrictions. These files include text and binary files. SMTP is a known protocol for sending and receiving mail over a TCP connection. This protocol defines the necessary components of the message, including sender, recipient and mail body. SNMP is a protocol defining network management and monitoring of network devices and their functions. Telnet is a known protocol that allows users to log onto remote hosts and use applications and files that they have been given permission to access. NNTP is a known protocol used to send and receive USENET postings between News clients and USENET servers. USENET is a collection of user submitted messages on various subjects posted to servers on a world wide network and sorted by subject into newsgroups.

When the data transfer protocol is HTTP, an HTTP proxy server can be used between a web browser and data nodes, providing the following advantages: faster response times when multiple Web Browsers are looking at the same data nodes, which may be important when the data nodes are slow to deliver data; reduced network traffic; and potentially hiding the true network address of the data node for security purposes, for example, so that client applications can only get to a proxied network address using HTTP.

In one embodiment, the data being transferred utilizes the Extensible Markup Language (“XML”) format. XML is a universal format for structured documents and data on the Web. It is a flexible, self-describing, vendor-neutral way to create common information formats and share both the format and the data over the connection. Using XML enables customization of data and views; for example, a custom view may contain a filter to remove unwanted data from the superset of data retrieved and present only the data required by the view.

As will be explained in detail further on, the computer 150 retrieves and processes data from one or more aforementioned data nodes 110-125 for the purpose of creating information to enable power management, data management or monitoring. Computer 150 also may transmit control data to the data nodes 110-125. Further, a second computer 160 may be coupled to the same network 140 transmitting and receiving data from the same or different data nodes 110-125. It will be appreciated that the first computer 150 and the second computer 160 can simultaneously display the same data from the same data nodes, yet derive different information content, i.e. process the data in a different manner, and display them in different formats for the users of different the first and second computers 150 160. It will also be appreciated that the number of data nodes 110-125 and the number of computer's 150, 160 coupled with the network 140 is unlimited.

Referring now to FIG. 2b, computer 150 includes Web Browser software that allows a user to view and control data nodes. A web browser is an application program that provides a way to view and interact with data on the world wide web, whether based on the Internet or an intranet or other TCP/IP enabled network. Web browsers can be text based or have a graphical user interface. An exemplary Web Browser is Internet Explorer™ version 5.5 or higher, manufactured by Microsoft Corporation, located in Redmond, Washington. Resource Files 215, located on the computer 150, are created by the Web Browser, by the vendor of the application files as described below, or by a user, and contain system and user information used by the Web Browser. The Resource Files 215 include browser resources, which are publicly available plug-ins and tools, as well as application files created by the vendor or by a user that together provide the application functionality. Browser resources include extensible stylesheet language transformation (“XSLT”) processors, XML parsers and scripting engines, all known in the art. Application files include files in various formats such as hypertext markup language (“HTML”), XML, XSLT and Jscript, all known in the art. Application files are persisted across Web Browser sessions by being created and stored on the computer 150. Where the Web Browser is Internet Explorer™, the application files are created and stored using Internet Explorer™ behaviors. Behaviors are lightweight, reusable components that encapsulate specific functionality or actions on a page. Once a custom behavior is defined, it can be easily applied across multiple pages, without having to write additional program code. Internet Explorer™ 5 and later versions implement several default behaviors and also allow custom behaviors to be created using scriptlets, which are small segments of Java code. Additional information regarding Behaviors may be found in the Behavior Handler Reference published by Microsoft Corporation, located in Redmond, Washington, and available at

http://msdn.microsoft.com/library/default.asp?url=/library/en-us/script56/html/letBHREF.asp (last accessed Jul. 24, 2002) and http://msdn.microsoft.com/library/default.asp?url=/library/en-us/odeopg/html/deovrunderstandingscriptletsbehaviors.asp (last accessed Jul. 24, 2002).

Computer 150 is coupled with a Network 140, which is further coupled with computer 160. Computer 160 contains Web Browser components, including a Web Browser display 219, Resource Files 218, a data retriever (not shown) that sends a command to data nodes on the network and retrieves power management data from the data nodes, and a data processor (not shown) that processes the power management data and may generate a command based on that power management data. The Network 140 is further coupled with several data sources 208, 210, 212. Data Source IED A 208 contains a Web Server 209 that serves up power management data A over the Network 140. Data Source IED B 210 contains a Web Server 211 that serves up power management data B over the Network 140. Data Source Back-end Server C 212 serves up power management data C over the Network 140.

When a user of computer 150 requests data from IED A 208 and IED B 210, the request is sent via the Network 140 to Web Servers 209, 211. Web Server 209 queries power management components (not shown) on IED A 208 for raw data. Web Server 209 then returns the raw data A via the Network 140. Web Server 211 concurrently queries power management components (not shown) on IED B 210 for raw data. Web Server 211 then returns the raw data B via the Network 140. Raw Data A, B is then received by computer 150. Computer 150 contains a Data Processing module 214 that combines raw data A, B and various Resource Files 215 and generates processed data A′, B′. Processing data entails performing value added function on the raw data, such as performing mathematical calculations, transforming the data into other units or formats, searching for various values, filtering out data, and taking action depending on the data retrieved, all to create information which fulfills the needs of the user. Combining data entails creating information by taking processed or unprocessed data from two or more sources and possibly applying further processing before rendering the information. The processed data A′, B′ is then displayed in the Web Browser window 216. It will be appreciated that the data processing module 214 is capable of processing data from one or more data sources.

When a second user of computer 160 requests raw data from IED B 210 and Back-end Server C 212, the request is sent via the Network 140 to Web Server 211 and Back-end Server C 212. Back-end Server C 212 has a Web Server (not shown) for handling such requests. Web Server 211 queries power management components (not shown) on IED B 210 for raw data. Web Server 211 then returns the raw data B via the Network 140. A Web Server component on Back-end Server C 212 concurrently queries power management components (not shown) for raw data. Back-end Server C 212 then returns the raw data C via the Network 140. Raw data B, C is received by computer 160. Computer 160 contains a Data Processing module 217 that combines raw data B, C and various Resource Files 218 and generates processed data B′, C′. This processed data B′, C′ is then displayed in the Web Browser window 219.

It will be appreciated that the disclosed embodiments require no additional applications such as local Web Servers, Excel or Enterprise Energy Management Software components to complete the above described processing. An advantage of this approach is avoiding the installation, configuration, maintenance and execution of these applications. Rather than requiring the installation of binary components, the present invention merely entails copying Resource Files 215 into a local folder on the computer 150, and starting the Web Browser, which is already installed on the computer 150. Alternately, where computer 160 does not have the required Application Files installed, a user is still able to run the application from any device coupled with the network 140. Referring again to FIG. 2b, Computer 160 is coupled via a network 213 with computer 206. Network 213 can be any type of network, including the Internet, an intranet, a wireless network or combinations thereof. Computer 206 contains Resource Files 207 including the necessary Application Files. Web Browser 219 located on computer 160 can access and use the Resource Files 207 on computer 206. In this instance there is no need to copy any files onto computer 160, though any user preference and customization selections will be stored as Resource Files 218 on computer 160. Standard network security known in the art between computer 160 and computer 207 ensures that Web Browser 219 can only access data files on computer 207 that the Web Browser 219 has permission to access.

The data displayed in the Web Browser 216, 219 can be displayed in a variety of formats including Text, Audio and Graphical, such as charts, diagrams, animation, vector diagrams, bar charts, scrolling banners, frames, audible signals and so forth. HTML Frames may also be used to allow the user to see multiple views/sections simultaneously in a browser window. In this case, a master frame file is used to control the sections of the framed display, allowing them to interact with each other. Technologies used to display these data formats include Scalable Vector Graphics (“SVG”). SVG is an XML format for describing image data using compelling, animated graphics, allowing the image to be automatically resized as the size of the display medium changes. It will be appreciated that the disclosed embodiments enable many ways of disseminating power management data besides display in a browser window, including emailing, paging and printing.

FIG. 2c illustrates a flow chart for retrieving and displaying power management data on the computer 150 depicted in FIG. 2b. A user starts a Web Browser 220 and launches a web page for displaying power management data 222. The Web Browser retrieves stored system and user data 224, including user preferences, default and custom views.

Views are textual or graphical templates which define the physical layout of the screen and the definition of what data appears in which screen locations but not the actual data itself. Default views are provided by the vendor as examples of potential screen layouts whereas custom views are tailored to a specific application or customer. Custom views can be created in a variety of ways, using any web page creation, graphics, word processing or spreadsheet application capable of saving files in a web browser compatible file format. Exemplary applications include the Microsoft Office suite, including FrontPage, PowerPoint, Visio, Word and Excel, manufactured by Microsoft Corporation, located in Redmond, Washington. Web pages created in accordance with the disclosed embodiments by any of these applications can be used to display power management data in a browser window.

Examples of custom views include: combining data from a variety of sources to create information; combining real time power management data with a preconfigured alarming limit and taking action if a certain value exceeds a given limit, where the action may be sending email, paging, or displaying an error condition; asking for a particular parameter and having all connected data nodes searched for that value; scheduling events to occur a certain times, such as timesyncing or delivery of emails or updates; filtering data to remove unwanted values; or transforming data from one format or unit to another format or unit.

Each view is stored as a Resource File 215. In one embodiment, the file type of the Resource File is Extensible Stylesheet Language (“XSL”). XSL is a language that describes how data sent over the World Wide Web using XML is to be presented to the user. XSL Transformations (“XSLT”), combine XML input with XSL instructions to transform the XML input into an XML document with a different structure. The XSLT can describe both the layout of the browser window and how the data is processed and formatted prior to display in the browser window. There are many advantages to using XSLT to translate XML documents; for example, the translator maintains a transparent view for the user, who doesn't need to know details about their XML source, such as IED version or type, to retrieve data. Further, once a view has been described in an XSLT file, reusing that view is as simple as selecting a group of data nodes and associating them with a previously created XSLT file; the result is a file with the same view format, but different source names and data displayed in that view. Alternately, data nodes can be added and removed with ease from an existing view. Yet another advantage is that XSLT rules can be used to combine data from diverse sources, eliminating the need for a Web Server to aggregate the data and provide it as an HTML page.

The Web Browser retrieves data from one or more data nodes 226. The data nodes are defined in the current view. When more than one data node is being queried, the data is retrieved concurrently. This parallel update provides a quicker response time and provides a better user experience. The retrieved data is processed to transform the data into the required format or view. The processing involves performing a function on the data, such as filtering, searching, combining, sizing, scheduling or taking action. The processed output is displayed 230 in the Web Browser. It will be appreciated that the user could simultaneously view multiple browser windows, displaying data from the same or different data nodes. If the user has chosen self-updating data and has not paused updates 234, or if the user has changed their view 238, the Web Browser will periodically return to the block of retrieving data from data nodes 226. If the user changes their preferences 236, this may affect the update interval 234. In addition, the user may enter a control command 240. The Web Browser transmits the control command to the data node 244, and returns to the block of retrieving data from the data node 226; this block could include receiving an acknowledgement that the control command was received and processed. The user can chose to save data 248 to view it again later or to combine it with other data to form a report. This can be a manual or automatic action.

The stored system and user data retrieved in block 224 may include addressing data for all data nodes previously provided by the user. Alternately, the Web Browser can query a registry such as a Web Service and retrieve a list of available data nodes. The registry service may be public or proprietary, and may be provided by the vendor, the customer or by a third party. The list can be assembled on the registry in a variety of ways including self-registration by the data nodes, manual addition to the registry, or automatic creation when the data nodes are deployed. Data from all available data nodes can then be retrieved and displayed in a view; alternately the user may then select which of the data nodes to add to a custom view. One advantage of this approach is that there is no need for the user to find which data nodes are available and enter addressing data for them.

In many applications, it is important for only authorized users to be able to transact with the data nodes. It is also important that the data nodes identify themselves in a trusted manner to the web browser and that the web browser can trust the data received has not been tampered with.

In one embodiment, data node authentication and data integrity is provided by the application of Public Key Infrastructure (“PKI”) and XML signing where the data node has a certificate and associated private and public keys issued by a trusted entity. PKI allows users of insecure networks to share data by utilizing a public key, private key scheme, where the keys are assigned by a trusted body, the public key is available to everybody, and the private key is known only by the owner. When a key owner is sending a document they can use the recipients public key to encrypt the document, use their own private key to sign the document and attach a certificate containing public information about the owner. A recipient of the document can use their own private key to decrypt the document, use the senders public key to verify the senders signature to ensure the document has not been corrupted or tampered with and use the senders certificate and verified signature to verify the identity of the sender. Signing important data within the document rather than using Secure Sockets Layer (“SSL”) provides integrity and authentication of the author of the document, as well as providing these benefits: signing is a more computationally efficient implementation than SSL; the XML document author and data integrity can be verified independently of the data transfer protocol that delivered it; and the document contains the signature of data within itself and the integrity can be verified at any time, whereas with SSL the data can only be verified at the time of the transaction. SSL is a commonly used protocol for sending documents securely over the Internet. SSL uses the public key, private key system described previously. For the purposes of this document, SSL is equivalent to its successor Transport Layer Security (“TLS”), and may be used interchangeably.

An alternative to XML signing is to sign documents and/or encrypt without respect to their structure. In other words, the entire document is treated as plain text. The signature and document would be sent through a scheme like Secure Multi-Purpose Internet Mail Extensions (“S/MIME”). S/MIME is a secure method for sending email. S/MIME describes how encryption information, signatures and digital certificate can be included as part of the message body.

In another embodiment, data node authentication and data integrity is provided by the application of SSL in conjunction with HTTP, known as Hypertext Transfer Protocol over Secure Socket Layer, or HTTP over SSL, or HTTPS. HTTPS encrypts and decrypts user requests as well as documents returned by the data node. Advantages of this approach are that the security model is well thought out, widely used and the HTTPS Universal Resource Locator (“URL”) scheme and protocol scheme is understood by many client applications and platforms. SSL is used to authenticate the data node to the web browser, encrypt data sent to the web browser, encrypt data sent to the data node, ensure data sent to the data node or the web browser has not been tampered with or corrupted, and optionally authenticate the web browsers identity using the web browsers public key and certificate.

When a data node sends data to a Web Browser it can encrypt and sign the data. When a Web Browser receives the data 226, it can decrypt and check the integrity and authenticity of the data source 246 before passing the data along for processing 228.

User authentication and control command encryption use the same technologies. In one embodiment, the user enters a control command 240 and is challenged for a password and optionally a user-id 242. The password and control command are encrypted 242 and sent to the device 244 using SSL and HTTP. The data node decrypts the command and password and optional user-id. If the data node is able to verify that the password is correct and that the user is authorized to issue the command, it takes the control action.

Alternately, the user could be identified to the data node using PKI techniques, which do not require a password exchange between the user and the data node. Instead, the control command is sent to the data node as signed XML over HTTP or HTTPS, or as a client authenticated HTTPS request. In either case the data node uses PKI techniques to authenticate the user and ensure the command has not been corrupted or tampered with before taking action.

FIG. 2d illustrates further detail for some of the blocks in FIG. 2c. The URL of a power management resource is selected automatically based on system data, by the user selecting the URL, or by the user entering a control command 238. In the next block, the web browser sends commands to and retrieves raw data from data nodes 226. This action is broken down into a number of discrete blocks 260-280. The web browser resolves the URL that the user has entered 260. The web browser retrieves the locally stored web page 264 where available, or the remotely stored web page 262, as identified by the URL. The web browser loads the web page and associated data processing modules 268. The web browser executes the web page and data processing modules 270, which are browser resource files. The remote power management data sources are sent control commands or queried for raw data 272. The web server servicing the data source receives the control command or data request 274, accesses the power management data or accepts the control command 276 and serves up the requested data or responds to the control command using known protocols. The raw data is received and verified by the web browser 280. A data processing module connected with the web browser processes the source data or response 228, prior to the processed data or response being displayed in the browser window 230.

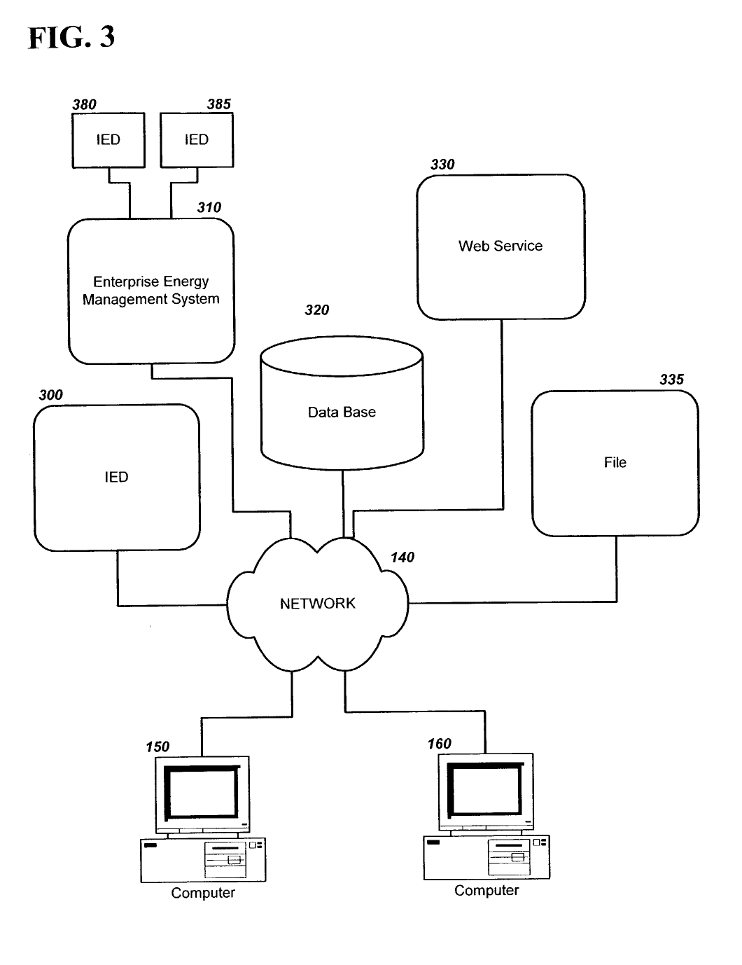

FIG. 3 schematically depicts the physical layout of one embodiment of a power management system comprising multiple computers 150, 160 coupled to the network 140. A variety of data nodes 300-335 are coupled to the network 140. Data nodes 300-335 include an IED 300, Enterprise Energy Management System (“EEMS”) 310 and Data Base 320. Alternately, a Web Server (not shown), Web Service 330 or Files 335 also provide data. Data from any of these data nodes may be combined and displayed simultaneously and dependently or independently on multiple devices, such as computers 150, 160. Further, computers 150, 160 may send control commands to the data nodes 300-335.

Where an IED 300 is a data node, the IED 300 may provide operation, power quality, consumption, event, financial, billing or environmental data as described earlier. Alternately, the IED 300 could provide device data, statistical data, load management data, fraud detection data, electrical power generation data, IED inventory data and data from other power management data nodes that are not capable of acting as data nodes themselves. Furthermore, the IED 300 can receive control commands to control IED inputs, outputs, settings and parameters. For example, control commands include opening and closing breakers, adjusting set-points, and tap changer control.

Where the Enterprise Energy Management System 310 provides an XML source, the data may include real time data from single or multiple IED's 380 385 coupled with the system, or historical data stored in a database in the system.

Alternately, where the data node is a Data Base 320, the Data Base 320 may provide Financial Data, such as energy pricing, power factor penalties, revenue and billing data, or other stored power management data. The Data Base may store data in various formats, including XML and Comma Separated Values (“CSV”). CSV is a format for storing tables in a flat file, where each row is on its own line, and each column is separated with a comma.

In operation the IED 300 serves up different kinds of data depending on what is requested. For example, real time energy data from IED 300 may be combined with real time energy pricing data from Web Service 330 and displayed on computer 150 for the purpose of monitoring the current energy charge. Simultaneously, historical logs stored on IED 300 may be combined with historical logs from IED's 380, 385 stored in a Data Base on EEMS 310 and served up by the EEMS 310 and displayed on computer 160 for the purposed of monitoring historical aggregated energy usage at a variety of sites.

Alternate data node combinations are combining real time readings from IED 300 and another IED (not shown), combining real time readings from IED's 380, 385 via EEMS 310 with real time energy pricing data from a Web Service 330, combining historical logs stored in a data base in EEMS 310 with historical energy cost data stored in Data Base 320, aggregating real time readings from IED 300 and another IED (not shown), combining the resulting data with alarming levels listed in File 335, and displaying an alarm condition if energy usage exceeds a set limit. Control examples include monitoring a system, taking an action such as opening or closing a breaker if the system gets into a certain state, and watching how the system reacts to the update; processing historical data, adjusting a meter parameter which affects meter behavior, and observing how the change affects the system; sending a rate table to the IED, allowing the IED to automatically calculate and control its load; using power management data from one IED to analyze the state of the system and send a control command to another IED based on that analysis.

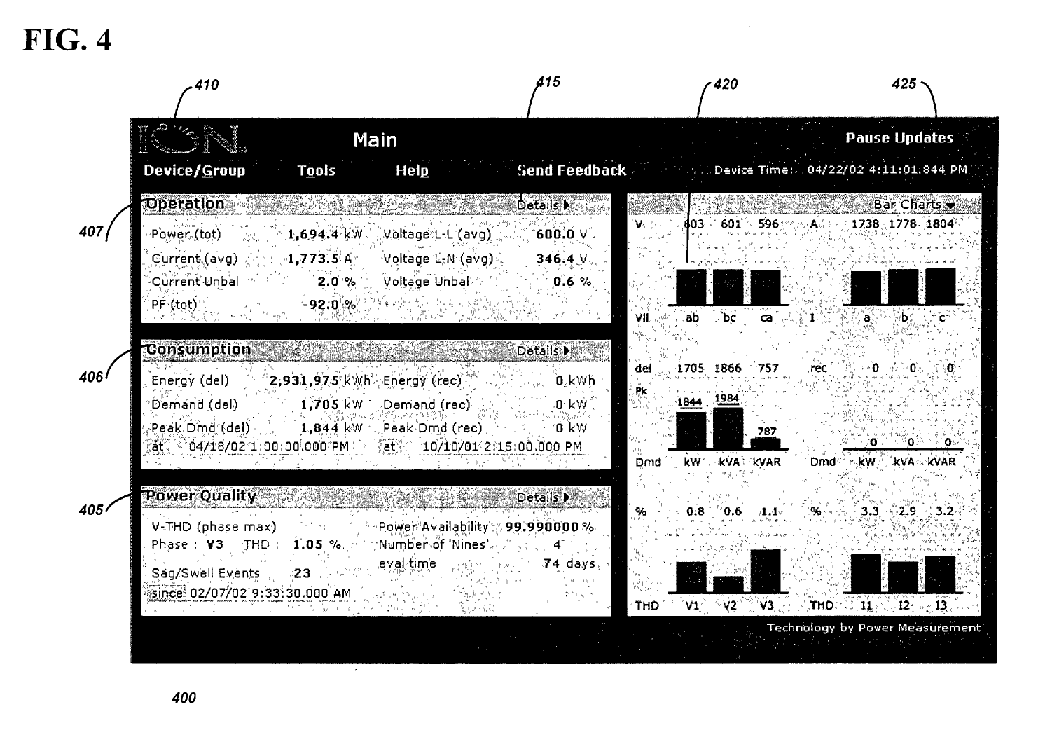

FIG. 4 illustrates an embodiment of displaying power management data from a single source in a browser window 400. Some examples of power management data are shown, including Power Quality data 405, Energy Consumption data 406 and Operation data 407. The Device/Group Menu 410 allows for easy toggling between single and multiple source views. The Details Tab 415 allows the user to zoom in on particular energy use areas. The window 420 on the right side of the browser window 400 illustrates the use of SVG to display automatically resizing charts. The Pause Updates button 425 in the top right hand corner of the browser window 400 allows the user to pause the automatic refresh of the browser window 400. It will be appreciated that although this example shows data from a single source, aggregated data could also be shown in the same format.

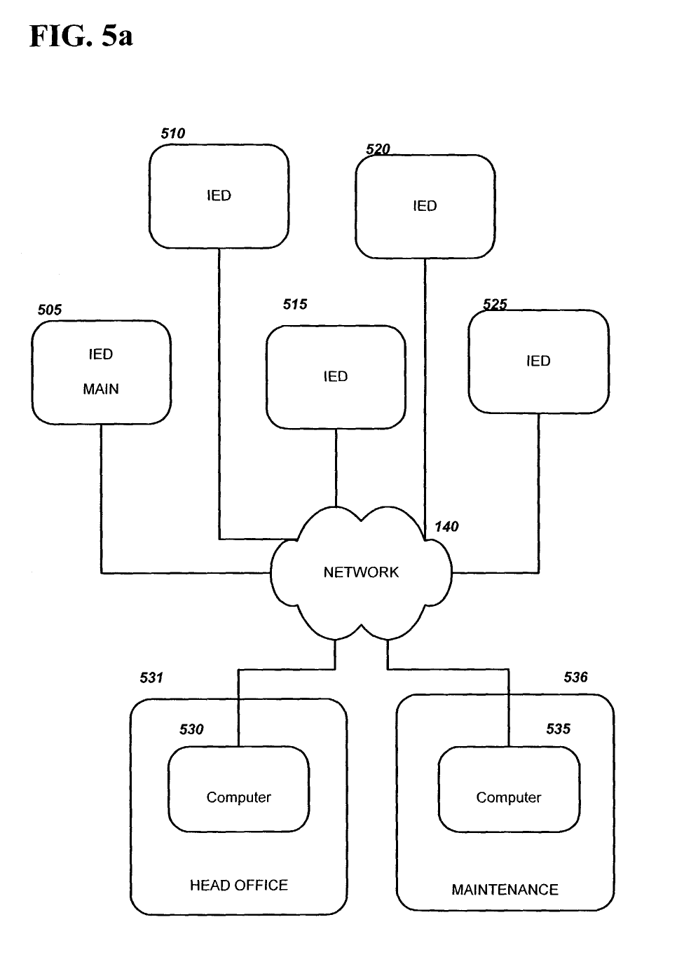

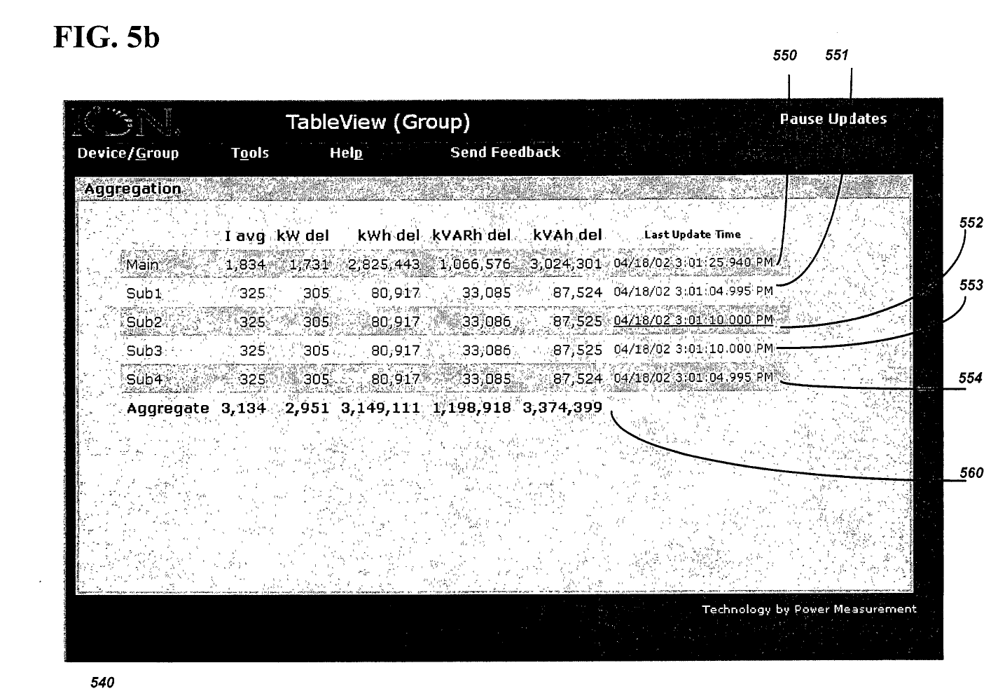

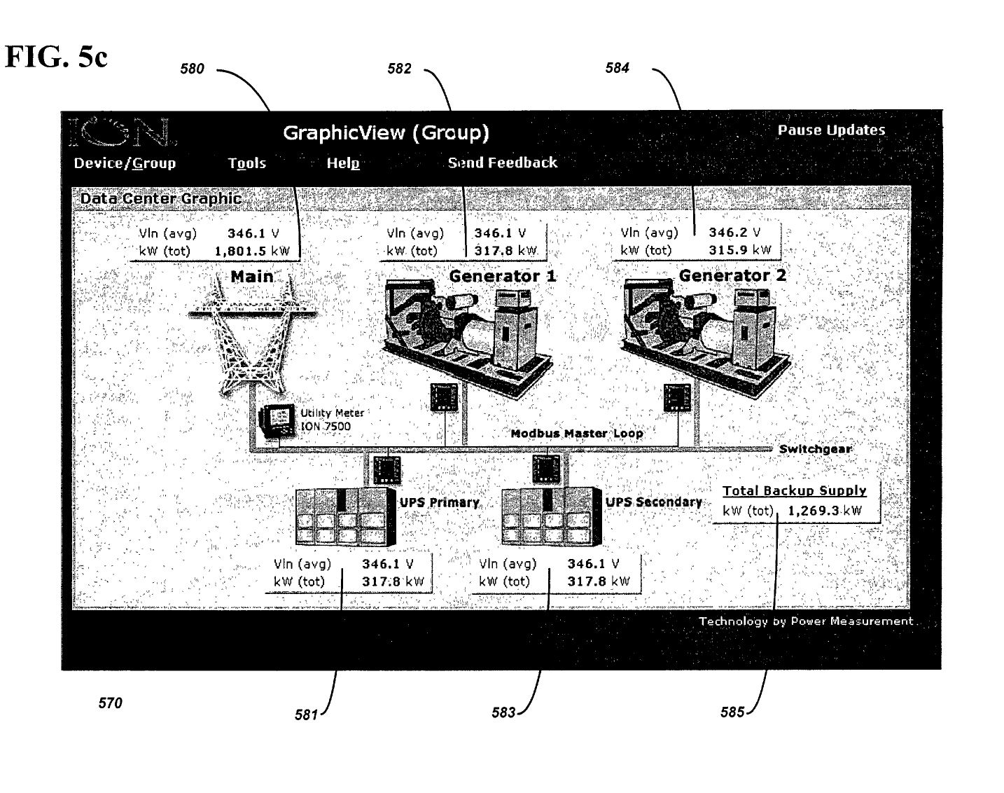

Referring now to FIG. 5a, a power management system is shown. The power management system comprises data nodes shown as IED's 505-525, each coupled with Network 140, which is further coupled with the Head Office computer 530 and Maintenance computer 535 located in the Head Office 531 and Maintenance Office 536 respectively. In operation the Head Office and Maintenance require data from the same five IED's, however the computers 530, 535 both require different views and data formatting for the end users. Head Office is watching total energy consumption and requires a table view to quickly view overall system energy usage and pinpoint which areas of the system have higher energy usage. Maintenance is monitoring system operation and prefers a graphical view, allowing for quick detection and resolution of any problems. Furthermore, Head Office and Maintenance refer to the same IED's 505-525 by different names. It will be appreciated that the Head Office 531 and the Maintenance Office 536 can be located in different geographic locations.

FIG. 5b illustrates an alternate embodiment for displaying power management data in a browser window 540 using the physical network depicted in FIG. 5a, where the browser window is displayed on Head Office computer 530. A first data line 550 depicts data from IED Main 505 depicted in FIG. 5a, including real time current and power values, cumulative power values and the time the values were last updated. A second data line Sub1 551 depicts data from IED 510 depicted in FIG. 5a; a third data line Sub2 552 depicts data from IED 515 depicted in FIG. 5a; a fourth data line Sub3 553 depicts data from IED 520 depicted in FIG. 5a; and a fifth data line Sub4 554 depicts data from IED 525 depicted in FIG. 5a. A sixth data line 560 is an aggregation of each column, presenting a summary of energy usage across the system. It will be appreciated that many other values could appear in this view, or that the format of the view could be other than table format, as described earlier, without changing the meaning of the invention. Indeed, the configurable nature of the invention allows each user to configure their display to best meet their needs.

FIG. 5c illustrates an alternate embodiment for displaying power management data in a browser window 570 using the physical network depicted in FIG. 5a, where the browser window is displayed on Maintenance computer 535. Each component in the system is depicted in a graphical format. A first image Main 580 depicts IED Main 505 depicted in FIG. 5a, describing voltage and power data for the IED. A second image UPS Primary 581 depicts IED 510 depicted in FIG. 5a; a third image Generator 1 582 depicts IED 515 depicted in FIG. 5a; a fourth image UPS Secondary 583 depicts IED 520 depicted in FIG. 5a; and a fifth image Generator 2 584 depicts IED 525 depicted in FIG. 5a. Total Backup Supply 585 is a sum of UPS Primary 581, UPS Secondary 583, Generator 1 582 and Generator 2 584.

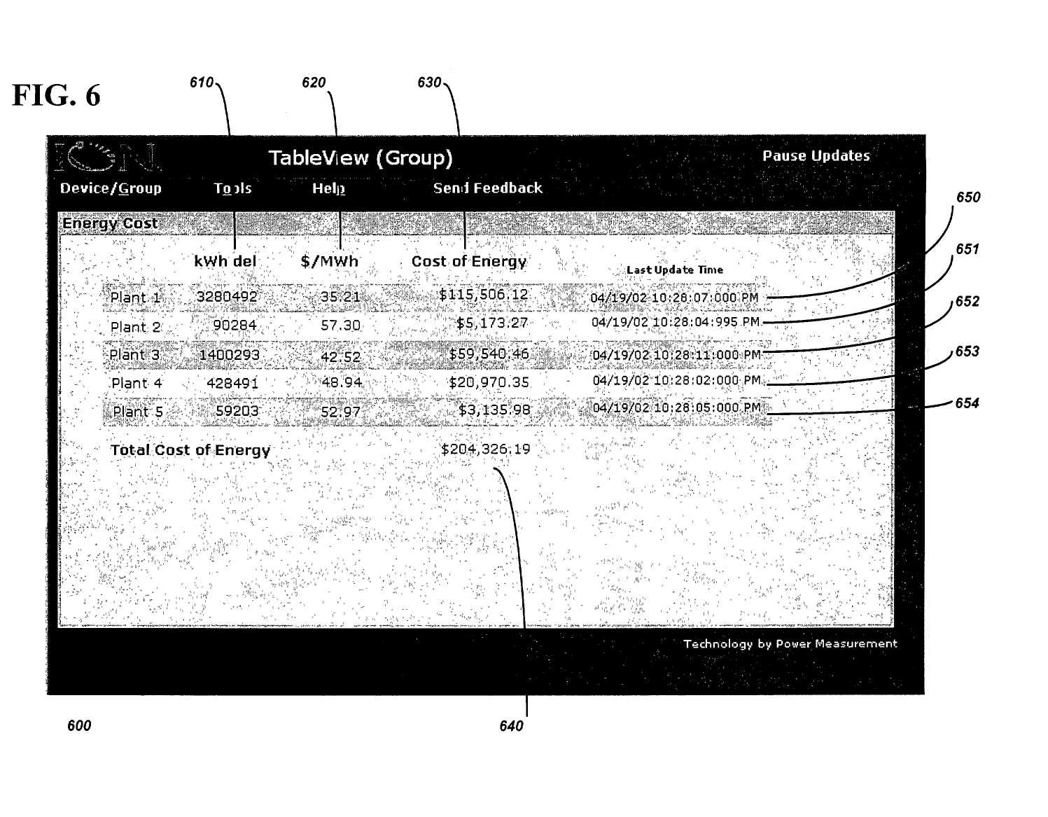

FIG. 6 illustrates an alternate embodiment for displaying power management data in a browser window 600. The table depicted in the browser window combines energy and financial data to produce system cost information for plants located in different geographical regions. The kWh column 610 lists accumulated kilo watt hour usage since the system was last reset. The $/MWh column 620 lists average price per mega watt hour since the system was last reset. Cost of Energy column 630 presents the product of kWh used 610 and price 620 since the system was last reset. Total Cost of Energy 640 presents the sum of energy usage across the system. A first data line 650 depicts data for Plant 1 (not shown) from several sources. Consumption is provided by an IED (not shown) onsite at Plant 1. Price per mega watt hour is provided by a financial Data Base (not shown). Cost of energy is calculated as a product of the total consumption and average price. A second data line 651 depicts energy cost data for Plant 2 (not shown); a third data line 652 depicts energy cost data for Plant 3 (not shown); a fourth data line 653 depicts energy cost data for Plant 4 (not shown); and a fifth data line 654 depicts energy cost data for Plant 5 (not shown).

The present invention can exist as part of a portal. A portal, also known as a gateway, is a World Wide Web site that is a major starting site for users, from which they can access other web sites and services. The present invention provides a simple to use and lightweight solution for viewing power management data and controlling energy system components that can easily be bundled with other services to form a portal.

It is therefore intended that the foregoing detailed description be regarded as illustrative rather than limiting, and that it be understood that it is the following claims, including all equivalents, that are intended to define the spirit and scope of this invention.

We claim:

1. An electrical power management system comprising:
a network;
a first intelligent electronic device (“IED”) coupled with said network operative to provide a power management function and at least one of receive control commands and provide power management data onto said network; and
a first computer coupled with said network, said first computer comprising a first web browser program, said first program operative to retrieve at least said power management data from said network and process said power management data;
wherein said first program is operative to present said processed power management data to a first user of said first computer.

2. The electrical power management system of claim 1, wherein said first IED comprises at least one of an electric meter and electrical relay.

3. The electrical power management system of claim 1 further comprising:
at least one data source coupled with said network operative to provide second data onto said network;
wherein said first web browser program is further operative to retrieve and process said power management data and said second data.

4. The electrical power management system of claim 3, wherein said first web browser program is further operative to substantially simultaneously retrieve said power management data and said second data.

5. The electrical power management system of claim 3, wherein said first web browser program is further operative to simultaneously present at least said processed power management data with at least one of said processed second data.

6. The electrical power management system of claim 3, wherein said at least one data source comprises a second IED.

7. The electrical power management system of claim 6, wherein said web browser program is further operative to transmit a command over said network to said second IED, said command comprising a control command, wherein said command is generated automatically based on said processed power management data.

8. The electrical power management system of claim 3, wherein said at least one data source comprises an enterprise energy management system.

9. The electrical power management system of claim 3, wherein said at least one data source comprises a database.

10. The electrical power management system of claim 3, wherein said at least one data source comprises a web service.

11. The electrical power management system of claim 3, wherein said at least one data source comprises an extensible markup language (“XML”) file.

12. The electrical power management system of claim 3, wherein said at least one data source comprises a non-power management data source operative to provide non-power management data.

13. The electrical power management system of claim 3, wherein said power management data is dynamic and where said second data is static.

14. The electrical power management system of claim 3 further comprising:
a second computer coupled with said network, said second computer comprising a second web browser program, said second program operative retrieve and process said power management data and said second data
wherein said second program is operative to present said processed power management data and said processed data to a second user of said second computer;

15. The electrical power management system of claim 1 further comprising:
a second computer coupled with said network, said second computer comprising a second web browser program, said second program operative to retrieve at least said power management data from said network and process said power management data;
wherein said second program is operative to present said processed power management data to a second user of said second computer.

16. The electrical power management system of claim 15, wherein said power management data source is further operative to substantially simultaneously provide said power management data to said first computer and said second computer.

17. The electrical power management system of claim 15, wherein said second computer is located geographically remote from said first computer.

18. The electrical power management system of claim 1, wherein said first IED provides said power management data to said first computer according to a data transfer protocol compatible with said first web browser program, said data transfer protocol comprising Hypertext Transport Protocol (“HTTP”).

19. The electrical power management system of claim 18, further comprising a HTTP proxy server coupled with said network, wherein said HTTP proxy server is operative to proxy communications between said first computer and said first IED.

20. The electrical power management system of claim 1, wherein said power management data comprises XML data.

21. The electrical power management system of claim 1, wherein said first computer comprises a display, said first program being further operative to display said processed power management data on said display

22. The electrical power management system of claim 21, wherein said display comprises scalable vector graphics (“SVG”).

23. The electrical power management system of claim 1, wherein said first computer comprises an email application, said first program being further operative to email said processed power management data on said email application.

24. The electrical power management system of claim 1, wherein said power management data is at least one of encrypted and signed prior to being provided over said network, and where said power management data is further at least one of decrypted and authenticated when it is retrieved.

25. The electrical power management system of claim 24, where said signing and authentication utilize extensible markup language (“XML”) signing.

26. The electrical power management system of claim 24, where said encryption, signing, decryption and authentication utilize at least one of secure sockets layer (“SSL”) and transport layer security (“TLS”).

27. The electrical power management system of claim 26, where said encryption, signing, decryption and authentication utilize Hypertext Transfer Protocol over Secure Socket Layer (“HTTPS”).

28. The electrical power management system of claim 1, wherein said web browser program is further operative to transmit a command over said network to said IED.

29. The electrical power management system of claim 28, wherein said command comprises a configuration command.

30. The electrical power management system of claim 28, wherein said command comprises a control command.

31. The electrical power management system of claim 30, wherein said command is generated by said first user.

32. The electrical power management system of claim 30, wherein said command is generated automatically based on said processed power management data.

33. The electrical power management system of claim 32, wherein said command comprises second power management data.

34. The electrical power management system of claim 1, wherein said power management function comprises at least one of monitoring electrical power distribution, monitoring, computing and reporting revenue, monitoring, computing and reporting power usage, monitoring, computing and reporting power quality, controlling electrical power flow, and load shedding.

35. The electrical power management system of claim 1, wherein said power management data comprises at least one of operations data, power quality data, consumption data, financial data, environmental data.

36. The electrical power management system of claim 1, further wherein said first web browser program is operative to execute a first web page file, said first web page file being operative to process said power management data.

37. The electrical power management system of claim 36, wherein said first web page file utilizes extensible stylesheet language transformation (“XSLT”) to process data.

38. The electrical power management system of claim 36, wherein said first web page file is stored on a second computer, said second computer coupled with said network, said first web browser program being further operative to retrieve said first web page file from said second computer over said network prior to said execution.

39. The electrical power management system of claim 38, wherein said second computer is further operative to store a plurality of second web page files, each of said plurality of second web page files operative to perform a data processing function.

40. The electrical power management system of claim 36, wherein said first web page file is operative to dynamically display at least one of text and graphical information.

41. The electrical power management system of claim 1, wherein said first web browser program is further operative to locate said first IED in a registry using a name lookup.

42. An application for use with an electrical power management system, said system comprising a network and an intelligent electronic device (“IED”) coupled with said network, said application comprising:
a data retriever operative to transmit a command and retrieve first power management data from said IED over said network;
a data processor operative to process said first power management data and generate said command; and
a graphic display operative to visually display at least said processed first power management data to a user of said application and receive input from said user;
wherein said application is operative to be executed by a web browser program, said web browser program executing on a first computer coupled with said network.

43. The application of claim 42, wherein said system further comprises a second power management data source, said data retriever further operative to retrieve second power management data from said second power management data source over said network, said data retriever further operative to transmit commands to said second power management data source over said network, said data processor further operative to process said second power management data, and wherein said graphic display is further operative to visually display at least one of said second power management data and said processed second power management data.

44. The application of claim 43, wherein said data processor comprises a graphical display template describing a first visual layout of said first power management data in said graphic display.

45. The application of claim 44, wherein said graphical display template further describes a second visual layout of said second power management data in said graphic display, wherein said second visual layout is similar to said first visual layout.

46. The application of claim 44, wherein said graphical display template and said application are further capable of being stored on said first computer using Microsoft Internet Explorer Behaviors.

47. The application of claim 42, said application further capable of being stored on a second computer coupled with said network and loaded into said web browser program over said network from said second computer.

48. The application of claim 42, wherein said data processor performs a processing function on said first power management data resulting in said processed power management data.

49. The application of claim 48, wherein said data processor is further operative to receive third data from at least one data source, said processing function based on said first power management data and said third data.

50. The application of claim 49, wherein said third data is stored in said data processor.

51. The application of claim 50, wherein said third data comprises a previous value of said first power management data.

52. The application of claim 49, wherein said processing function comprises presenting said first power management data juxtaposed with said third data to said user.

53. The application of claim 48, wherein said processing function comprises computing a maximum value of said first power management data.

54. The application of claim 48, wherein said processing function comprises annotating said first power management data.

55. The application of claim 48, wherein said processing function comprises plotting said first power management data in a graphic coordinate system to create a graph and displaying said graph to a user.

56. The application of claim 48, wherein said processing function comprises converting said first power management data from a first form to a second form and displaying at least said second form to said user.

57. The application of claim 56, wherein said first form is numeric and said second form is graphical.

58. The application of claim 56, wherein said first form comprises a first unit scale and said second form comprises a second unit scale different from said first unit scale.

59. The application of claim 48, wherein said processing function comprises comparing said first power management data to a first pre-defined threshold and alerting said user when said power management data deviates from said first pre-defined threshold.

60. The application of claim 48, wherein said processing function is further operative to generate a command to said power management data source based on said first power management data.

61. The application of claim 48, wherein said processing function is further operative to generate a command to poll said power management data source to send said first power management data to said data receiver.

62. A method of presenting power management data in a web browser, said web browser coupled with a network and further coupled with at least one power management data source, the method comprising:
a) retrieving at least one power management data response from said at least one power management data source over said network by said web browser;
b) processing said at least one data response in said web browser; and
c) displaying said processed data in said web browser.

63. The method of claim 62, wherein said processing further comprises filtering said at least one data response.

64. The method of claim 62, wherein said processing further comprises comparing said at least one data response.

65. The method of claim 62, wherein said processing further comprises searching said at least one data response.

66. The method of claim 62, wherein said processing further comprises scheduling said at least one data response.

67. The method of claim 62, wherein said processing further comprises storing said processed power management data on a storage device coupled with said first computer.

68. The method of claim 62, said web browser further coupled with a second data source, wherein a) further comprises retrieving a second data response from said second data source, and further wherein b) comprises combining said second data response and said at least one power management data response.

69. A method of controlling the power management function of an IED, said IED coupled with a network and further coupled with at least one web browser, the method comprising:
a) retrieving power management data from said IED;
b) processing said power management data in said web browser to create processed data;
c) generating a control command based on said processed data and sending said control command to said IED for the purpose of controlling a power management function on said IED; and
d) transmitting said control command to said IED.

70. The method of claim 69, wherein said generating a control command is automated based on said processed power management data.

71. The method of claim 69, wherein said generating a control command is further based on input by a user of said web browser.

72. An electrical power management system for managing an electrical power distribution system comprising:
a network;
at least one intelligent electronic device (“IED”) coupled with a portion of said electrical power distribution system and further coupled with said network, each of said at least one IED operative to implement a power management function in conjunction with said portion of said electrical power distribution system, said power management function operative to respond to at least one power management command and generate power management data, each of said at least one IED comprising:
a first network interface operative to couple said at least one IED with said network and facilitate transmission of said power management data and receipt of said at least one power management command over said network;
said system further comprising:
a power management application coupled with said network and operative to receive and process said power management data from said at least one IED and generate said at least one power management command to said at least one IED to implement said power management function; and
at least one computer coupled with said network, said computer comprising an internet browser program, said internet browser program operative to retrieve said power management data from said at least one IED and process said power management data;
wherein said internet browser program is operative to present said processed power management data from said internet browser program to a first user of said at least one computer.

73. The electrical power management system of claim 72, wherein said IED further comprises a security module coupled with said first network interface and operative to prevent unauthorized access to said power management data.
